(19) United States
(12) Patent Application Publication
(10) Pub. No.: US 2010/0166950 A1
(43) Pub. Date: Jul. 1, 2010

(54) METHOD AND EQUIPMENT FOR PRODUCING AN OPTICAL PIECE

(75) Inventor: Olavi Nieminen, Vanhalinna (FI)

Correspondence Address: OLIFF & BERRIDGE, PLC, P.O. BOX 320850, ALEXANDRIA, VA, 22320-4850, US

(73) Assignee: THETA OPTICS LTD OY, Lieto (FI)

(21) Appl. No.: 12/667,103

(22) PCT Filed: Jul. 3, 2008
(86) PCT No.: PCT/FI2008/050405

§ 371 Date: Dec. 29, 2009

(30) Foreign Application Priority Data
Jul. 4, 2007 (FI) 20075512

(51) Int. Cl. G02B 1/10; B05C 5/00

(52) U.S. Cl. 427/163.1; 118/300

(57) ABSTRACT

A method and equipment for producing an optical piece. The method comprises coating an optical work piece with at least one functional coating and dispensing the coating material onto the optical work piece by a microjet printer. Finally, a plural number of optical pieces are detached from the coated work piece.

### BACKGROUND OF THE INVENTION

The invention relates to a method for producing an optical piece, the method comprising coating the optical piece with at least one functional coating.

The invention further relates to equipment for producing an optical piece, the equipment comprising means for coating the optical piece with at least one functional coating.

Any external source of light interferes with equipment provided with a display and used outside on a sunny weather or indoors in premises provided with lighting. This is true for all displays both in portable and stationary devices. Among the most typical devices are for example GPS (Global Positioning System) devices, computers, television displays, laptops, mobile phones and other telecommunications devices. The same problem appears for example in instrument panels and windows of automobiles, boats, aircraft, and in clocks, instruments, solar panels, etc.

Prior art knows a number of methods for producing an Anti-Reflection (AR) function. An optical product is desired to have a perfect AR function, i.e. a light reflectivity of less than 1.5%. The most commonly applied method is multi-layer broadband coating, which is widely used in eyeglass industry, for example.

A problem is that the technology for coating eyeglasses is extremely expensive to apply because it involves a significant number of manual work phases. The coating method applied to eyeglasses is based on a vacuum technology, in which piece goods are processed, i.e. the work process is directed to individual objects and therefore requires various separate product-specific jigs, or holders, for the objects. For example, the product range of mobile phones alone is extremely large and therefore also their display protection lenses are of significantly different sizes and shapes, i.e. there is no standard form of display shield.

A problem thus arises from the fact that a single product segment alone, such as the mobile phones, represents vast product volumes. Today, over 1 billion mobile phones are manufactured annually, and the number of different models being manufactured simultaneously is 100-200. The life cycle of the models is typically not more than 3 to 6 months, whereby the volumes per model are not particularly high. This means that in the mobile phone industry, for example, it is not even possible to manufacture products into storage with the methods used today.

### SUMMARY OF THE INVENTION

It is an object of the invention to provide a novel and improved method and equipment.

The method of the invention is characterized by producing the optical work piece by extrusion, dispensing a coating material onto the optical work piece by a microjet printer, a plural number of optical pieces being detachable from the coated work piece.

The equipment of the invention is characterized in that it comprises a microjet printer configured to dispense coating material onto the optical work piece and means for detaching a plural number of optical pieces from the coated work piece.

The method and equipment of the invention allow optical products to be produced, such as display protectors or protection lenses, which are typically planar. Examples of these include windows protecting the displays of mobile phones, GPS devices and portable computers, display protectors in general and films for LED, plasma, TFT, LCD, and OLED displays. The optical products may appear not only on mobile phones, GPS devices or portable computers but also on televisions, automates, vehicle instrument clusters, etc. More generally speaking, the optical product may be any product used in an attempt to influence the travel of light.

Future display protectors are expected to possess various simultaneous characteristics. For example, the display protector may be a lens or a protective window separate from the actual display device generating the information to be displayed, or an outermost plastic film integrated into a display device the functioning of which may be based on a TFT, plasma, LCD or OLED principle, for example. Among the most typical characteristics required of a display protector are: anti-reflection, or reflection-blocking function, hard coating, touch-sensitive functionality, and IR (Infra Red) blocking.

Eyeglasses, for example, are made both from glass and plastic. Some of the plastic materials, known per se, that are used for manufacturing eyeglasses are CR 39, polyamide, such as PA12, and polycarbonate. When eyeglasses are made of plastic, the plastic material is mould into a three-dimensional shape to provide a work piece for forming an eyeglass lens, the work piece being then coated with desired coatings. The coating process thus involves processing separate work pieces each one of which is then formed into one optical piece, i.e. one eyeglass lens in this case.

Instead of moulding, the method of the invention uses extrusion to form a work piece, which is then coated with desired coatings and from which a plural number of optical pieces may be detached. The surface of the work piece may be 1 m², for example.

According to an embodiment of the invention a microjet method is used in the coating, both for creating a first hard coating made of varnish and sol-gel surface composites of a hard AR surface.

### BRIEF DESCRIPTION OF THE FIGURES

Some embodiments of the invention will be explained in greater detail with reference to the following drawings, in which

FIG. 1 is a schematic side view of a part of an optical piece of the invention with its structural layers separated from one another;

FIG. 2 is a schematic top view of a second optical work piece of the invention;

FIG. 3 is a schematic view of a method and equipment of the invention;

FIG. 4 is a schematic side view of a part of an optical piece according to a third embodiment of the invention with its structural layers separated from one another;

FIG. 5 is a schematic side view of a part of an optical piece according to a fourth embodiment of the invention;

FIG. 6 is a schematic side view of a second method and equipment of the invention;

FIG. 7 is a schematic top view of a fifth optical work piece of the invention;

FIG. 8 is a schematic view of a third method and equipment of the invention;

FIG. 9 is a schematic side view of a part of an optical piece according to a sixth embodiment of the invention with its structural layers separated from one another;

FIG. 10 is a schematic side view of a prior art optical piece arranged onto a display;

FIG. 11 is a schematic side view of a second prior art optical piece arranged onto a display;

FIG. 12 is a schematic side view of an optical piece according to a seventh embodiment of the invention arranged onto a display;

FIG. 13 is a schematic view of a suitable microjet printer in the process of coating a substrate:

FIG. 14 is a schematic top view of a coating result obtained by the microjet printer of FIG. 13; and

FIG. 15 is a schematic view of a method of the invention and equipment used in the method.

For the sake of clarity, some embodiments of the invention shown in the Figures are simplified. Like parts are indicated with like reference numerals.

### DETAILED DESCRIPTION OF SOME EMBODIMENTS OF THE INVENTION

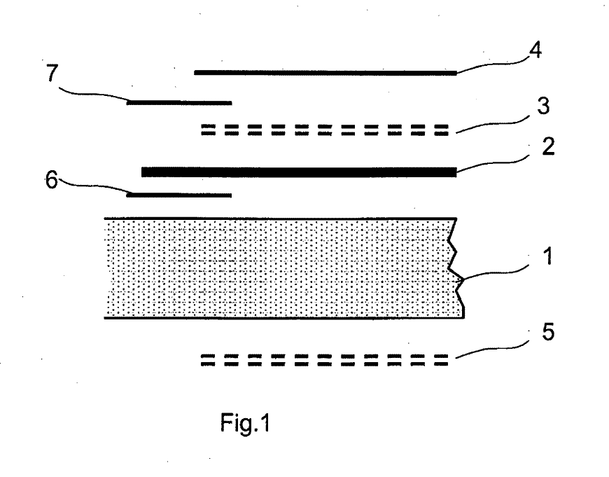

FIG. 1 is a schematic side view of a part of an optical piece of the invention with its structural layers separated from one another. Both sides of a work piece 1 are provided with AR hard surfaces 5 and 3 using sol-gel method, a hard varnish surface 2 being provided underneath the outermost sol-gel surface.

Although sol-gel coating materials are extremely hard, it is commonly known that they cannot withstand strong, high surface stress independently. Prior art knows a solution in which siloxane varnish is mixed with a sol-gel coating material, and ultraviolet hardening is applied as one hardening method. A problem with this solution is that an inorganic sol-gel coating material does not react with UV light, i.e. the hardness of the surface largely depends on the organic varnish. If the Fresnel formula is applied, the thickness of this type of coating is ¼ of the length of the reference wave, for example 560 nm, whereby the maximum thickness of the surface would be 145 nm. The bearing capacity of a surface of this thickness is extremely low, irrespective of the substance concerned. Sol-gel coating is specifically applied to obtain AR functionality and therefore the refractive index of the coating in question must be extremely small, most preferably less than 1.27. Irrespective of whether the sol-gel coating material Is transferred onto a varnish layer or an adhesion layer, the surface in question must be of a homogeneously uniform thickness and have an impeccably even morphological surface. Neither dip-varnishing nor spin-coating is able to produce such surface quality.

The surface tension of the plastic work piece may be modified by different chemical processes. However, the substances used in them are carsinogenic, which is why their use is not recommended in the slightest. According to the method of the invention, surface tension is modified using a corona plasma treatment that produces an excellent result and, in addition, is entirely free of toxins.

According to an embodiment of the method of the invention, an organic varnish that may comprise inorganic nanoparticles is deposited underneath an inorganic sol-gel coating material in such a way that a fully solid bond is formed between both surfaces. The first coating, which is typically a varnish coating having a thickness of 5 to 15 μm, is deposited onto the surface of the optical work piece by a microjet device, such as an oscillating printer. Next, solvent is entirely removed from this varnish coating so that the layer is at least dry to touch. The varnish coating is then provided with a sol-gel layer deposited thereon, the layer being typically 50 to 200 nm thick. Solvents, which are preferably similar to those in the organic varnish layer underneath, are removed also from this coating. As a result, an extremely hard bond is created between the coatings.

The sol-gel coating may be hardened with microwaves without affecting the properties of the varnish underneath, and the varnish in turn may be hardened using UV light. Using microwaves for hardening the sol-gel coating materials creates an extremely hard covalent bond in the sol-gel coating.

Since according to the new method all coating materials are most preferably spread by microspraying, an optimal surface thickness and morphologically uniform surface are obtained. It is therefore also possible to apply coating materials that include a catalyst, i.e. materials of at least two components. One of their advantages is that they enable two different surfaces to be bonded without external energy.

Optionally, printing works and/or metal coating 6, 7 may be carried out by printing, for example. The sol-gel method also serves as the most advantageous means for depositing an anti-fog coating 4.

The work piece 1 is made of extruded viscous material, such as plastic, for example PC, PMMA, PA or PS plastic grades. The work piece 1 may be provided with functional features, such as anti-reflection, hard coating, touch screen functionality and/or IR blocking.

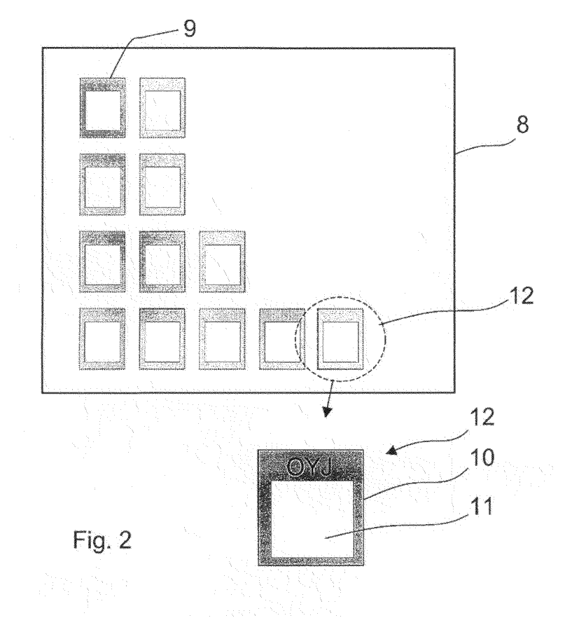

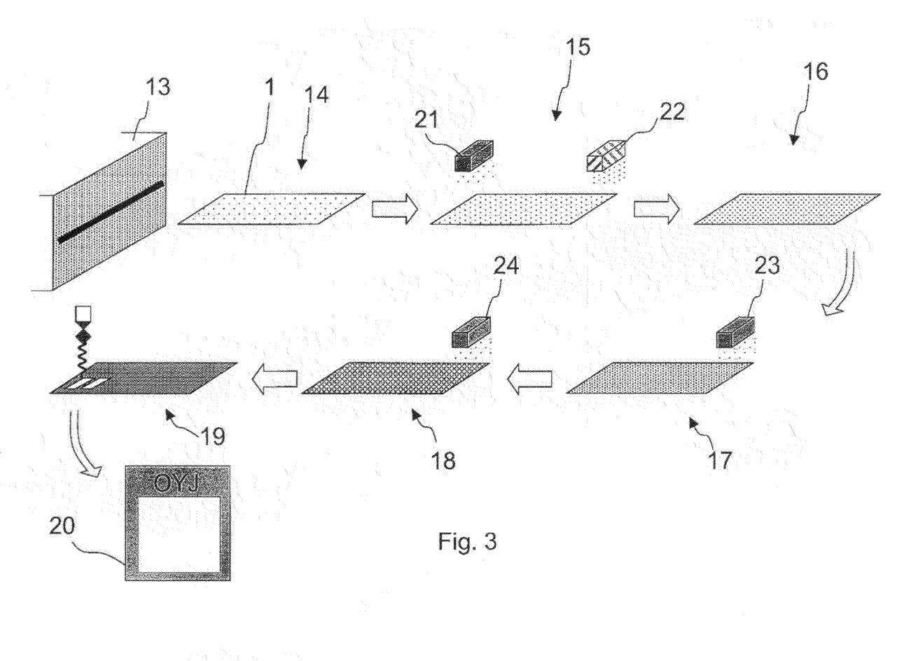

FIG. 2 is a schematic top view of a second optical work piece of the invention. The work piece has been made by extrusion and it may be a plate 8, for example, whose dimensions in the coating phase may be for example 1 m×1 m and which has product areas 9 formed thereon using the equipment and method shown in FIG. 3, for example. An area of 1 m×1 m may contain 300 product areas 9 of 50 mm×50 mm, for example, from which protective lenses 12 are made by cutting them off from the plate 8. A protective lens 12 may comprise not only an optically transparent area 11 but also a decorative area 10, for example.

The plate 8 may be subjected to the following processes, for example:

1. Adhesion coating to improve adhesion between the plate 8 and the coating to be applied thereon.

2. Hard coating, which may be implemented for example by means of varnish, such as siloxane varnish. This may comprise one or more of the following substances:
a) a silane monomer improving adhesion, for example a material known by the trade name GYMO;
b) a silane monomer, such as Si(OC₂H₅)₄, which is a material known by the trade name TEOS, to improve the hard surface function;
c) a sol-gel nanoparticle, such as Al₂O₃, TiO₂, ZrO₂;
d) a solvent, such as methoxypropanol;
e) a viscosity-adjusting component, known for example by the trade name BYK 340.

3. Anti-reflection coating. This may be made by using a sol-gel solution, for example, that comprises nanoparticles and has a coating refraction coefficient of less than about 1.30, or by using a fluorated polymer also having a refraction coefficient of less than about 1.30.

4. Decorative coating, or printing. This may be implemented in the form of a four-colour inkjet printing, for example.

5. Touch screen coating, which may be made using an electrically conductive varnish or printing colour, for example, such as the hard coating varnish mentioned under item 2, with ITO (Indium Tin Oxide) added therein.

The above processes are typically carried out in the given order, although this is by no means necessary. Decorative printing, for example, may be produced at any stage, and even onto the other side of the plate 8.

A typical feature of the method is that the coating processes are based on digitally controlled jetting methods, which will be discussed later in this specification. In addition, the coating processes used are usually what are known as wet processes. A further typical feature of the method is that it is used for producing a plural number of different coatings onto the surface of the work piece and that all the coatings are hardened into their final shape together and in the same end-coating process. For example, the procedure may be as follows: first an adhesion coating is applied and hardened to a hardness degree of about 50% of its final hardness. Next, a hard coating of a thickness of 5 to 10 μm, for example, is applied thereon and hardened to 30%. The hard coating is then provided with a touch screen coating applied thereon and hardened to 20%, and on top of this is deposited an AR and anti-fog coating, which may be made of fluorated polymer and have a thickness of 125 nm, for example, and from which solvent is evaporated. When this has been completed follows final hardening, which is preferably made using microwaves of a frequency of 3 GHz, for example, for a radiation time of 5 min. This is one example of the method that allows an extremely firm adhesion to be provided between the different coatings. Adjacent coatings bond to each other preferably by covalent bonds.

The hardness of the coatings and their adhesion are interrelated, and therefore the energies and the hardening time to be applied must be precisely adjustable. As already stated above, an advantageous hardening method is based on microwaves. The values of microwave hardening may be for example: frequency 3 GHz, power 1000 W/100 cm² and radiation time 5 min.

FIG. 3 is a schematic view of a method and equipment of the invention. In this integrated production system all coating work processes are carried out on one and only one side of the work piece 1. In the embodiment of FIG. 3 the coating work processes include plasma etching 14, piezo coating with a varnish 15, decorative coating 21 and hard coating 22, and also hardening 16 of the varnish on the work piece by means of infrared (IR), ultraviolet (UV) or microwave radiation (MW), or thermally.

The first work process is plasma etching 14, which is implemented for example in the form of corona plasma etching on the side of the work piece 1 that is subjected to the coating processes.

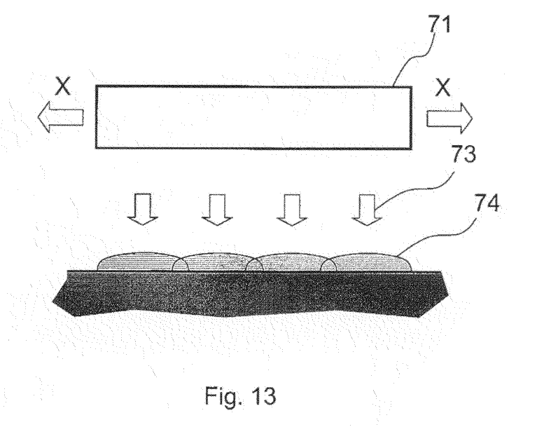

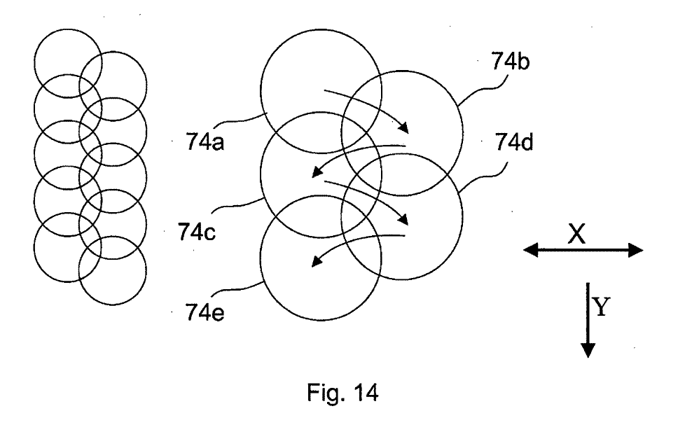

The next work phase is hard coating, which is implemented by microspraying, using for example piezo-controlled spray equipment 22 that may comprise a commonly known inkjet printer, piezo-operated pressure jetting device (passive), piezo-operated line jetting device (active) or an oscillating microjet printer. Microjet printing is typically based on a piezo element and represents a printing system in which each separate nozzle may be independently controlled, and the size of each droplet and their number may be program-controlled. The method enables precise selective coating in the coating application and controlling the variation of surface thickness with precision. In a piezo-operated pressure jetting function (passive) pressurized varnish is dispensed in droplets by a fast-acting piezo valve. All nozzles of the actual nozzle module always receive an identical pressure simultaneously from a pump through a valve. The system is suitable for uniform surfaces, in which the thickness of the surface to be produced is constant throughout the area. The pressure controlled by the piezo valve is extremely high, typically over 10 Mpa (100 bar), even 200 Mpa (2000 bar). In piezo-operated line jetting (active), pre-pressurized varnish is rapidly dispensed in droplets in a nozzle module by means of a sturdy piezo element from a plural number of nozzles simultaneously, typically from more than five nozzle openings per piezo element. The system is suitable for uniform surfaces, in which the surface thickness to be produced is constant throughout the area. The actual jet pressure is produced at a jet head with a piezo element. Hence, the pre-pressure does not need to be high; it is typically less than 10 MPa (100 bar). An oscillating microjet printer is discussed in greater detail in connection with FIGS. 13 and 14.

Digital printing is carried out at the same time, most preferably by means of piezo-controlled spray equipment 21.

Air or IR drying is followed by hardening 16 of the varnish by IR, UV or MW radiation, or thermally.

As a result, a first hard coating is produced on the side of the product under manufacture that will receive the rest of the coating as well, i.e. the outer surface of the product or the surface that may be subjected to a physical force. The varnish surface is typically 4 to 8 μm thick and nanofilled. The plastic plate or film then continues directly to an AR hard coating unit 17, where the sol-gel method is used for forming hard AR-function coatings by jetting/spraying, for example by means of spray equipment 23. The operation of the spray equipment 21, 22, 23, 24 may be based on the following methods, for example:

1. Commonly known inkjet printing

2. Piezo-operated pressure jetting

3. Piezo-operated line jetting

4. Oscillating microjet printing.

1. Inkjet Printing

A printing system typically based on a piezo element. Each individual nozzle may be independently controlled and the size and amount of each droplet may be adjusted by programming. Enables a precise selective coating and a precise control of surface thickness variation in a coating application.

2. Piezo-operated pressure jetting, passive. Pressurized varnish is dispensed in droplets by a fast-acting piezo element. All nozzles of the actual nozzle module always receive an identical pressure simultaneously from a pump through a valve. The system is suitable for uniform surfaces, in which the surface thickness to be produced is constant throughout the area concerned. Piezo-valve-controlled pressure is extremely high, typically over 10 MPa (100 bar), even 200 MPa (2000 bar).

3. Piezo-operated line jet, active. Pre-pressurized varnish is rapidly dispensed in droplets in a nozzle module by means of a robust piezo element from a plural number of nozzles simultaneously, typically from more than five nozzle openings per piezo element. The system is suitable for uniform surfaces, in which the surface thickness to be produced is constant throughout the area concerned. The actual jet pressure is produced at a jet head with a piezo element. Hence, the pre-pressure does not need to be high; it is typically less than 10 MPa (100 bar).

4. Oscillating microjet printing. This is discussed in greater detail in connection with FIGS. 13 and 14.

All spraying alternatives may include a varnish-heating component integrated into the nozzle head to allow high-viscosity varnishes to be used.

FIG. 13 is a schematic view of a suitable microjet printer in the process of coating a substrate. A nozzle unit 71 oscillates in direction X, i.e. in transverse direction to the direction of travel, i.e. direction Y, of the substrate to be coated. The extent of oscillation is at least ±0.01-2.0 mm, i.e. at least the distance between two nozzles. Hence the varnish droplets 74 do not settle (entirely or partly) one on top of the other in horizontal direction X alone, but also in direction Y, i.e. they are vertically superimposed as well. This is shown in greater detail in FIG. 14. The frequency of oscillation can be chosen in range of, for instance, 1 to 100 000 Hz.

FIG. 14 is a schematic top view of a coating result obtained with the microjet printer of FIG. 13. Oscillation in direction X combined with movement Y, i.e. the travel path of the product, which is for example 2 m/min, has an equal effect on the produced morphological evenness of the coating surface as on the general evenness of the surface.

Because of the oscillation in direction X and the movement in direction Y, the next droplet 74b after the first droplet 74a (sol-gel, varnish or any substance) becomes slightly offset and partly overlaps droplet 74a. When the next droplet 74c is added, it overlaps both droplet 74b and droplet 74a, etc.

According to an embodiment of the invention the oscillation of the nozzle unit 71 may be interrupted for a desired period and then resumed again. If necessary, the entire substrate may be coated using a non-oscillating nozzle unit 71. Oscillation, its extent and/or frequency may be advantageously adjusted and controlled by digital control means known per se. This allows both to produce an extremely uniform surface of a high optical quality and to define the area to be coated with precision.

Examples of coatings that may be produced using an oscillating microjet printer include hard coating as well as IR-blocking, UV-blocking, AR, anti-fog and other functional coatings, in which the variation in thickness is small and a good morphological surface evenness is required.

Using an oscillating microjet printer for spreading sol-gel coatings allows highly effective AR surfaces to be produced, because they enable a surface thickness of a thickness tolerance of ±1.25% to be achieved. With prior art inkjet printing solutions this is not possible.

An oscillating inkjet printer can also be used for spreading thicker coatings, such as varnish coatings of 3 to 30 μm, without difficulties, even if they contained nanofillers, as varnish products always do. Also this is impossible to achieve by prior art inkjet printer solutions, because nanofillers, such as TiO₂, ZrO₂, Al₂O₃, TaO₅, SiO₂, oxides in general, or ceramic nanofillers pack exactly to the spot where the printer nozzles place them. Adding more solvent does not help in this case either, because then the viscosity of the coating material drops so low that sagging is caused, which is not controllable. Sagging in a coating area means that the surface thickness is not constant, and therefore the coating is not useful at least when optical or functional coatings are prepared.

An optimal coating material viscosity is 9 to 20 cPs at a coating material temperature of +20° C. to +30° C. The viscosity of the coating material itself may be higher, for example 30 cPs at a temperature of +20° C., but the jet printing head may be provided with a heating component that allows the viscosity to be decreased to an optimal level of 9 to 15 cPs when the substance reaches the jetting nozzle. In that case the solvent content of the coating material may be considerably lower and yet a viscosity level required by the nozzle is achieved. The printer head may be kept at a temperature of 75° C., for example.

If the work piece is a multilayer composite structure, it may continue directly to the second sol-gel coating process 18, followed by sol-gel surface hardening carried out similarly as varnish hardening, i.e. by means of infrared (IR), ultraviolet (UV) or microwave (MW) radiation, or thermally.

Usually a plural number of different sol-gel surfaces are formed, e.g. three composite surface layers. It is therefore advantageous to have a plural number of coating units one after the other to perform the final sol-gel coating by means of piezo-controlled spray equipment 24, for example.

The sol-gel coating phase is followed by hardening of the sol-gel surfaces, which is performed similarly as varnish hardening, i.e. by means of IR, UV or MW, or thermally.

According to an embodiment of the invention the different varnish layers, or a varnish layer and a sol-gel layer are superimposed in what is known as a wet phase, i.e. before UV, MW, thermal or other hardening of the layers. This means that the different layers are seamlessly attached to one another, and no adhesion layer is needed between the layers. For this reason sol-gel coating processes are preferably integrated into one and the same work process.

An integrated production system, in which both the varnish and the sol-gel layer or a second varnish layer are placed on top of the product, is preferably at least partly sealed from the environment. The work processes can thus be carried out in an inert gas atmosphere, such as argon, nitrogen, xenon, helium, dry air, etc.

The space in which the coating and/or the drying processes are carried out may be sealed from the environment by arranging the work piece to travel into an enclosed channel, a first end of which is closed with a first liquid container filled with water, for example, and a second end of which is closed with a second liquid container filled with water, for example. The first liquid container may be provided with ultrasound equipment, for example, for washing the product piece in an ultrasound wash. At the liquid containers the work piece is first guided underneath the surface of the liquid and then returned back above the surface. The closed channel is preferably provided with microwave hardening devices of an operating frequency of 1 MHz to 500 GHz, for example. An advantage of the closed channel is that the microwaves do not escape into the environment.

The work piece may contain for example 300 preforms 9. After the coating processes they are cut out 19 by means of laser, water jet cutter, milling or a combination of these, or by using a similar means of detachment.

It should be noted that the coating processes may comprise at least the following: corona plasma handling, hard coating with varnish by means of a piezo-controlled jetting equipment, sol-gel coating produced using piezo-controlled jetting equipment, deposition of a surface providing a touch-sensitive function, digitally controlled printing and creation of an anti-fog surface. The coating processes preferably form a uniform continuous work process.

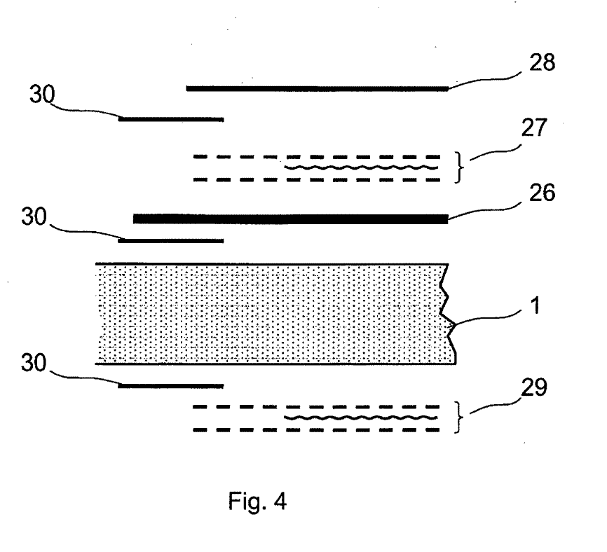

FIG. 4 is a schematic side view of a part of an optical piece according to a third embodiment of the invention with its structural layers separated from one another.

The work piece 1 is made of undoped plastic or plastic doped with additives, such as inorganic fillers. Examples of fillers may include CNT, or carbon nano tubes, fullerenes, such as C₆₀, oxide-based nanoparticles, such as SiO₂, ZrO₂, TaO₂, Al₂O₃.

Both sides of the work piece 1 are first provided with a primer coating 30. The primer coating, or adhesion coating 30, improves the adhesion of the next coating layer, i.e. the hard coating 26, onto the surface of the work piece 1. Primer layer materials will be discussed later in this specification. The primer layer 30 may contain materials due to which it also serves as a functional layer, such as a UV- or IR-blocking layer, or a photochromatic layer. The primer layer 30 may contain nanoparticles that increase the hardness of the layer. The primer layer 30 may serve as a basis for the sol-gel coating functioning as an AR coating. The thickness of the primer coating 30 is typically 500 to 2000 nm, for example.

The hard coating 26 is typically 5 to 25 μm thick. The primer coating 30 may serve as a resilient layer allowing a movement between the work piece 1 and the hard coating 26, the movement being caused by the difference in their thermal expansion coefficients. This helps to prevent the hard coating 26 from peeling off the work piece 1.

The sol-gel coating 27 is deposited onto the hard coating 26. The sol-gel coating 27 is typically inorganic but may be incorporated into an organic binding material, such as a urethane or siloxane varnish. The sol-gel coating 27 may receive another hard coating 30 on top of it.

The coating, indicated with reference numeral 28, may be an anti-fog coating or a touch-sensitive coating providing a touch screen, for example. The anti-fog coating may be made of fluorated polymer, for example, which may preferably also serve as an AR-function coating, provided that its refraction index sufficiently low. The coating creating the touch screen may be formed of varnish doped with electrically conductive material, such as indium tin oxide, for example. The thickness of the coating 28 may be 50-500 nm, for example, most preferably about 125 nm.

Most preferably the above coatings 26 to 28 and 30 can be hardened by microwaves, and even so that the previous coating is hardened only partly, at the most, before the next coating is deposited thereon, whereby the final hardening of all the coatings takes place simultaneously.

The bottom surface of the work piece is provided with an AR-function film 29 attached thereon by laminating, for example.

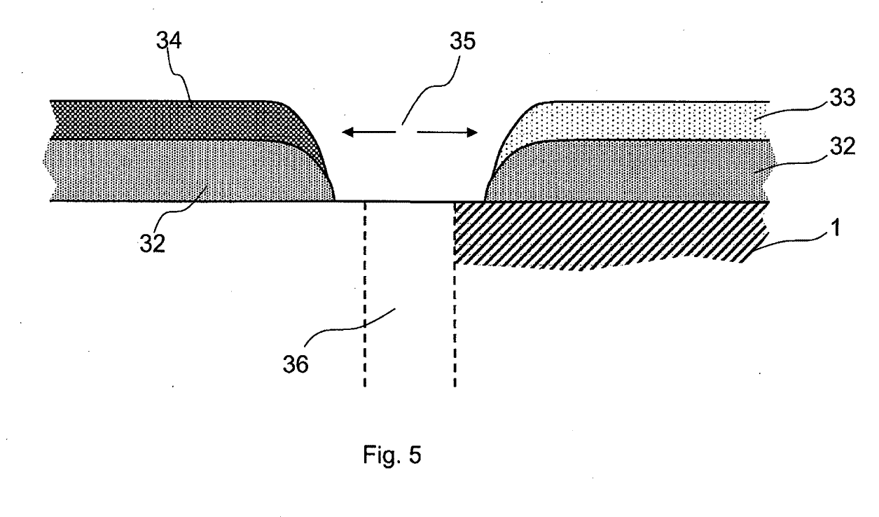

FIG. 5 is a schematic side view of an optical piece according to a fourth embodiment of the invention.

The work piece 31 is coated with a hard varnish layer 32 and sol-gel AR hard surface layers 33, 34. These layers are suitably modified for laser cutting 36. The coatings 32, 33, 34, and possibly partly also the work piece 31 itself, are provided with a groove 35 milled by a diamond-tipped mill grinder, for example. At least in certain materials this procedure is necessary, if laser cutting is used to carry out the final detachment. Otherwise the laser beam is difficult to calibrate so as to obtain an optimal cutting mark when the beam penetrates through three different materials, for example, i.e. through the plastic material 33 of the work piece itself, the hard varnish surface 32 and the sol-gel AR hard surface 33, 34. The milling does not penetrate the plastic 31, or penetrates it partly, but in any case at least part of the piece remains attached to the preform.

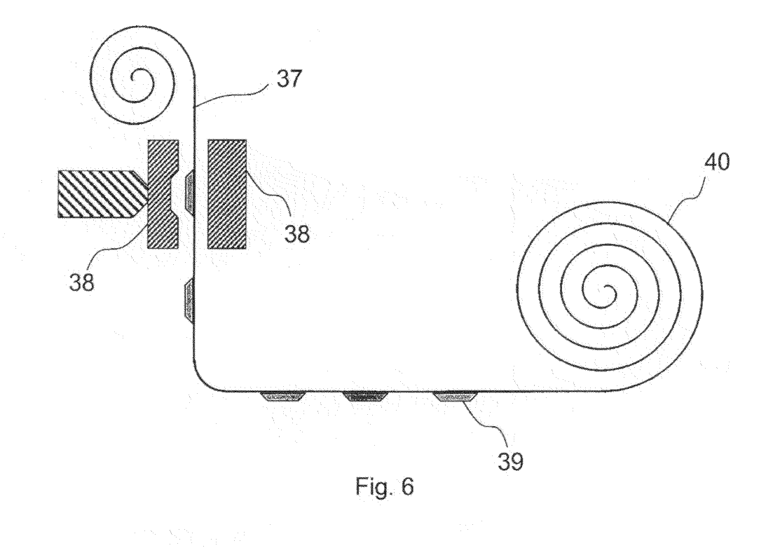

FIG. 6 is a schematic view of a second method and equipment of the invention. This method is carried out using an injection moulding process, in which a film 37 provided with an AR function is guided to travel through injection moulding cavities 38. In the injection moulding process the AR-function film 37 becomes attached as an integral part of the end product 39, which in this case is an optical display protector, and may be rolled into a roll 40, for example. In this application it is advantageous to perform the printing, such as a decorative printing or galvanic metallization, logo, frame, etc., onto the AR-function film 37.

A common feature of some injection moulding and extrusion applications of the invention is that in both the inner side, i.e. the second surface, is provided with an AR-function plastic film having a thickness of 20 to 200 μm. In both cases the AR film forms a part of the end product and both contain more than one work piece or end product. In this respect the situation is therefore the same as in the plastic plate 8 of FIG. 2 with more than one product areas 9, for example 300. The coating process is not subjected to a separate product with finished physical properties in either case.

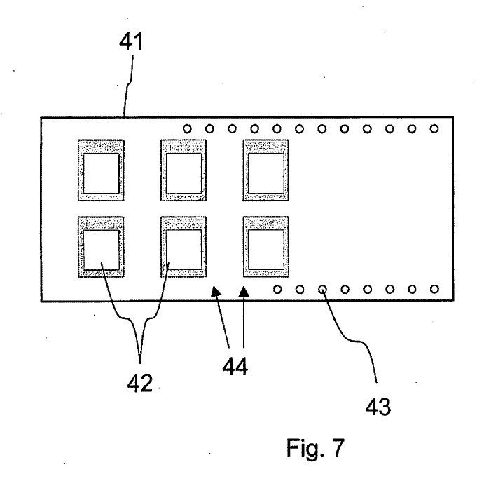

FIG. 7 is a schematic top view of a fifth optical work piece according to the invention. The end products, i.e. the display protectors 42, are placed into the AR-function film 41 so that there are two of them, for example, side by side, their location with respect to previous display protectors being always constant. The constant distance to previous work pieces facilitates significantly the coating processes, such as automated cut-off.

The AR-function film 41 may also be perforated 43 so that it becomes part of a conveyor. It should be noted that the work pieces 42, or the display protectors, still form an integral part of the AR-function film 41. The cut-off is only carried out as the very last work process, after all the coating processes.

The AR-function film used in FIG. 7 is similar to the one in FIG. 2, which is an example of an extrusion application. The only difference is that in FIG. 7 the product areas 42 are injection-moulded, whereby the AR-function film becomes part of the product area 42. Also in this case more than one end product, such as a protective lens 42, is placed on top of the AR-function film 41.

As to injection-moulded work pieces 42 (FIG. 7), they are also detached e.g. by laser cutting or by milling.

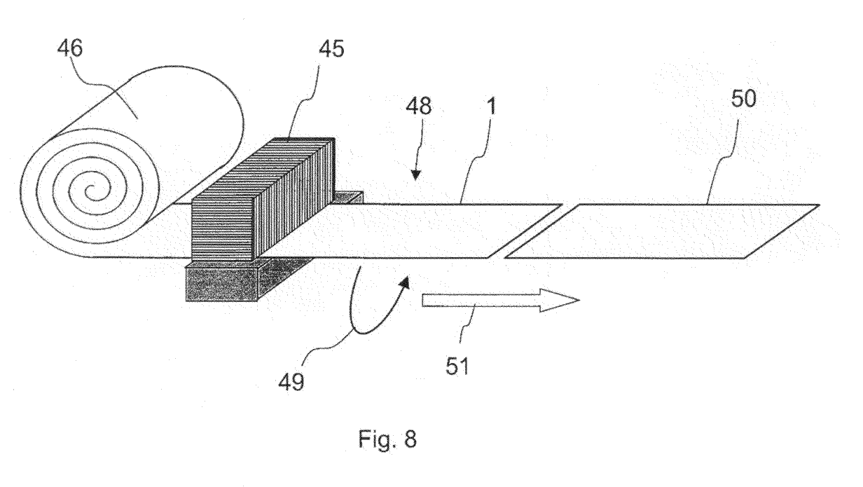

FIG. 8 is a schematic view of a third method and equipment of the invention. Here the AR-function film 46, which is typically in a roll form, is placed in association with an extrusion machine 45. In the extrusion process the AR-function film becomes an integral part of one side 49 of the plastic plate/film 1, while the outer side 48 consists of extruded plastic alone.

The AR-function film 46 is fed into the extrusion machine 45 at the same rate as new plate material 50 is produced, typically at a rate of about 5 m/min. The AR-function film 46 is a plastic film with a typical thickness of 10 to 200 μm, and it is attached to the work piece or the preform either in the extrusion phase (FIG. 8) or in the injection-moulding phase (FIG. 6) 37 to form part of the work piece 39. The AR function has been created by means of a microstructure, produced for example as a “moth eye” pattern made by rolling, by sputtering a multi-layer structure of different oxides, or by using a sol-gel method together with the Fresnel equation. The AR-function film 46 is most preferably formed using a roll-to-roll film vacuum evaporation method.

Work processes following the extrusion process and related to coatings may be carried out immediately after the extrusion and the lamination, or the plastic plate may be rolled, cut into plates or sheets of a suitable length and subjected to the coating processes at a later stage.

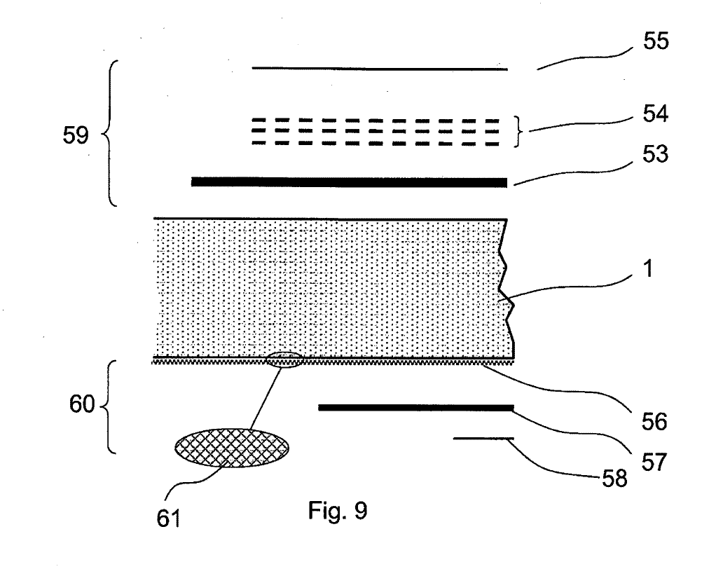

FIG. 9 is a schematic side view of a part of an optical piece according to a sixth embodiment of the invention with the structural layers detached. All the coatings made after the injection-moulding or extrusion phase are deposited onto one side of the product, typically onto the outer side 59 of the work piece 52.

The outer side 59 has been provided with a hard coating by means of a hard varnish 53, which is most preferably a nanofilled varnish, because it provides greater hardness and mechanical resistance. In addition, an appropriately nanofilled varnish has the same thermal expansion coefficient as the base. On top of the hard coating there is provided a single- or multi-layer sol-gel AR and hard coating 54 and further, on top of the latter, an anti-fog coating 56, also made using the sol-gel method.

The surface on the inside 60 of the work piece 52 may be provided with glue, tape 57 or a print.

FIG. 9 shows combinations of different surface composites of an optical display protector produced according to an embodiment of the invention and deposited on both sides of the optical work piece 52. On the inside 60 of the work piece, i.e. on the surface that will be closest to the display, is the AR-function film 56. The AR-function film 56 may be structured, calendered, or the AR surface may be created using a vacuum evaporation method, such as sputtering, or the sol-gel method 61.

The AR-function film 56 may be provided with tape film 57 and/or a print 58 attached thereto, but no attempt is made to influence its optical properties, because the AR index of the AR-function film is already as good as possible, i.e. its light transmission capability is over 99.5%.

The second coating 54 is a single- or multi-layer hard sol-gel AR coating of a total thickness of 30 to 400 nm.

The third coating 55 is an anti-fog soil repellent sol-gel surface that may also form a part of the previous sol-gel surface 54.

The following are typical coating thickness values:

| | | | |
|---|---|---|---|
| 53 | Hard varnish | 19 3-8 | μm |
| 54 | Sol-gel AR | 30-500 | nm |
| 55 | Sol-gel/Anti-fog | 10-70 | nm. |

The structure of FIG. 9 allows reflections to be eliminated almost completely. A normal light transmission capability is about 90%, whereas in the new application of FIG. 9 it is typically 99.75%.

All coatings, for example those shown in FIG. 3, are most preferably deposited on one side only, i.e. on the outer side 59 or the side that forms the contact surface, i.e. the physical outer surface, of the end product.

The method of the invention enables extremely affordable high-volume production of display protection lenses having an AR index, i.e. antireflection, of the same order as the best eyeglasses, i.e. a light transmission capability of typically over 99%.

To achieve this, the AR function must typically be provided on both sides, i.e. on the inner and the outer side, of the work piece 52. In a preferred embodiment of the invention this is solved by providing the AR function on the inner side 60 of the product 52 by means of an AR-function plastic film 56, which is integrated into the work piece 52 during the extrusion or injection-moulding phase. In that case all the work processes shown in FIG. 3 are carried out on only one side of the work piece 52, i.e. its outer side 59.

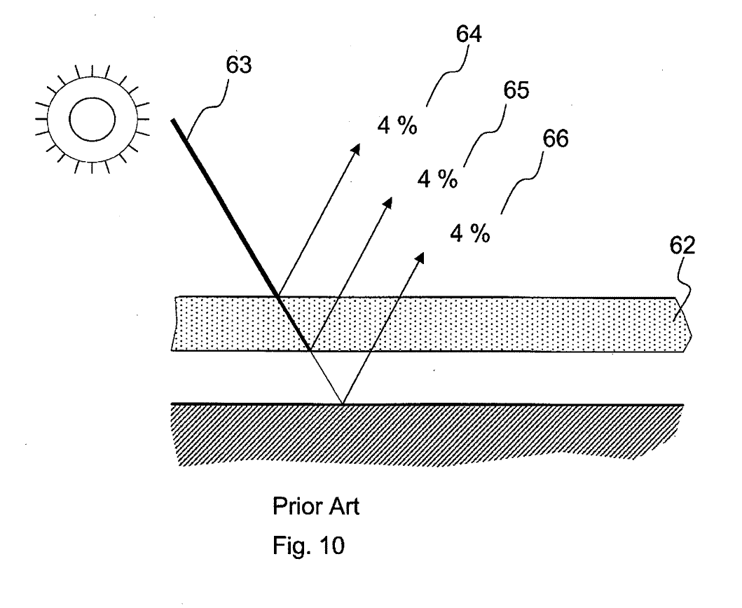

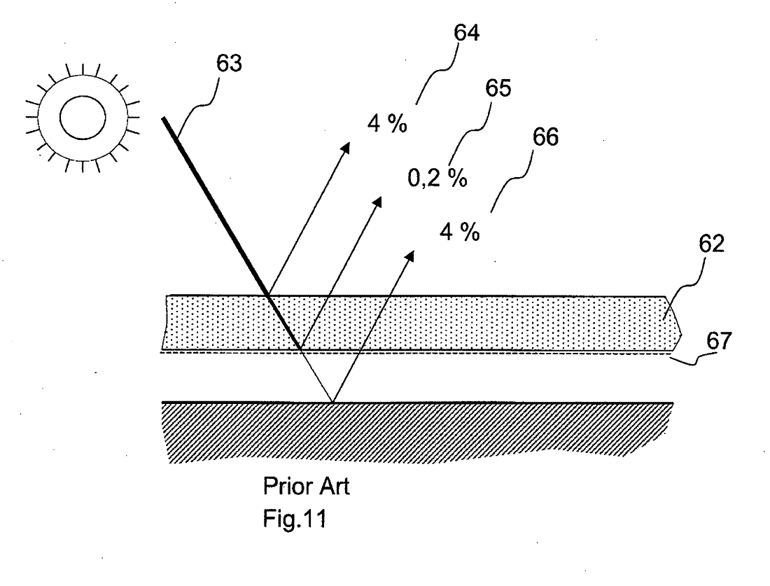

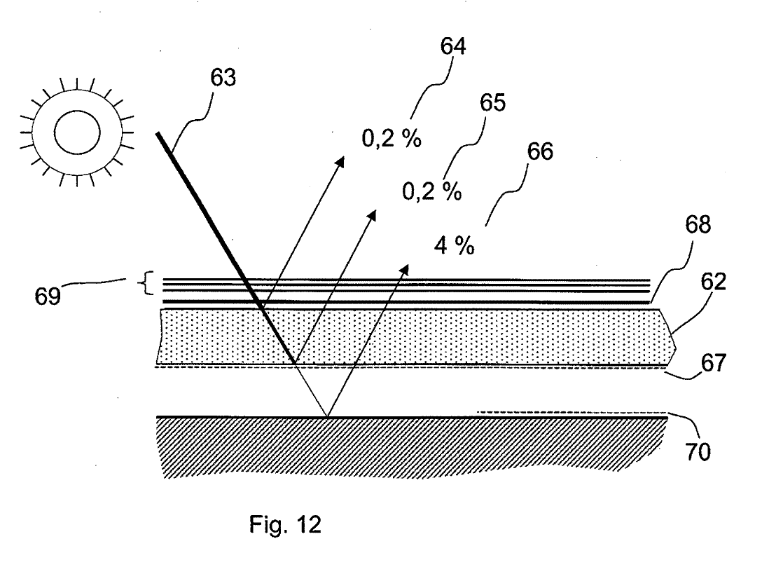

FIG. 10 is a schematic side view of a prior art optical piece placed onto a display, FIG. 11 is a schematic side view of a second optical piece placed onto a display, and FIG. 12 is a schematic side view of an optical piece according to a seventh embodiment of the invention placed onto a display. FIGS. 10, 11 and 12 show how light reflections occur and how they are eliminated.

FIG. 10 illustrates the current situation, in which at least 4% of light 63 is typically reflected from a first surface of the display protector 62, 4% also from a second surface and, similarly, at least 4% of light is reflected from the surface 66 of the display itself.

FIG. 11 shows how the situation improves when the inner bottom surface 65 of the display protector is provided with an AR surface 67. The reflection drops to less than 4%, typically to less than 0.2%.

FIG. 12 illustrates a display protector 62 produced according to the new method and having an AR-function film 67 on the underside, a reflection of about 0.2% and AR-function surfaces 69 on the outermost side 62 of the display protector, whereby the reflection of the outermost surface also decreases to less than 4%, to less than 0.5%, and typically to 0.2%. Hence the display protector 62 is practically antireflective, but the display itself still reflects about 4% of the light. A simple way to eliminate the reflection is to provide the display surface with an AR-function film 70. This eliminates interfering reflection light entirely.

Another noteworthy application of the new method is to use it on a display protector 62 provided with an AR-function film 67 and having a reflection which is as low as about 0.5 to 0.2%, in which case it is possible to achieve a partly optimal end result only by using a varnish surface 68 with an anti-glare property, because the lower surface 67 of the display protector 62 does not reflect light.

Generally speaking, one of the objectives is to provide a viscous substance, such as plastic, with as hard a surface as possible, but still retain the good qualities of plastic, such as impact resistance, easy and simple modifiability, possibility to include additional functions, etc. Basically, the aim is to achieve both the hardness of glass and the impact resistance of plastic.

Plastic as such cannot be as hard as glass, such as Bk7 or quartz glass. A known method for changing specifically the surface hardness of plastic is by hard-coating it with for example acrylate-, siloxane- or epoxy-based coatings, which are commonly referred to as varnishes. The coating may be carried out for example by dip-, air spray or spin-coat varnishing methods, or by previously unknown digitally controlled microjet methods.

If the aim is to produce an extremely hard surface, i.e. a quartz-like surface, while still retaining the excellent properties of plastic, it is necessary to act on the hardness qualities of the plastic itself. No matter how hard the surface to be deposited onto the work piece is, it is not possible to have a coating of such thickness that its properties alone would provide a surface hardness corresponding to glass when the surface is subjected to a strain. The reason for this is that the thermal expansion factors of plastic and coating are so different that a coating that is too thick simply peels off. A typical maximum thickness of a hard coating, such as siloxane varnish, applied directly onto plastic is about 6 μm. On the other hand, if an intermediate primer coating is used, such as urethane, polyurethane, epoxy, siloxane, or other similar primer coating, the thickness of the hard coating may be increased to more than 10 μm, for example to 20 μm. A typical maximum thickness of a surface produced by dip-varnishing is 4 μm. But even an extremely hard coating of a thickness of 25 μm, for example, which represents an extremely thick coating, would not, as such, provide a surface that would have a glass-like hardness when subjected to strain. This is because the base material, i.e. the plastic, is soft and therefore the coating will yield under strain. Only by acting also on the hardness properties of the plastic is it possible to obtain a comprehensive solution combining the desired good qualities of both glass and plastic.

It is naturally possible to act on the polymer structure of the plastic itself, but this does not provide the necessary added value. Instead, hardness is primarily influenced by integrating specific filler materials into the plastic raw material. It is known per se to include inorganic filler materials into an organic viscous substance, such as plastic and varnishes. For example, adding fibreglass and glass filler into plastic is a long-established practice. Likewise, quartz or glass nanoparticles have been added to varnishes for greater hardness, and titanium oxide particles for changing the refraction index. A problem here is that when nanoparticles having a size of 10 to 30 nm, for example, are integrated into plastic or varnish, they tend to cluster, i.e. coagulate into non-specific groups. As regards varnish, one way to solve the problem is by coating the nanoparticles, such as SiO₂ particles of 20 nm, with a siloxane coating. The coated nanoparticles can then be integrated directly into the varnish, for example. With plastic, however, problems may arise because the nanoparticles do not necessarily disperse uniformly into a dry plastic material, such as granulates or powder.

Therefore nanoparticles, whether coated or not, although coating is preferred, are most preferably mixed into the plastic raw material in what is known as the wet phase. For polycarbonate (PC) and epoxy, for example, this would mean that in connection with the manufacturing of the plastic, the nanoparticle is added into one of the components of the plastic, for example into BISFENOL-A of epoxy. This allows a fully homogenously doped plastic grade containing nanoparticles to be prepared. Thus a work piece made of such plastic grade may be coated with a coating containing a fully homogenously distributed nanoparticle mass. Because of its homogeneity, the coating has a precise layer thickness that may be over 5 μm, most preferably over 10 μm. The microjet method allows an optimal coating thickness with a thickness tolerance of less than ±5%, most preferably less than ±1%, to be achieved for the entire coating.

In addition to oxides, the filler may consist of carbon nano tubes (CNT) or fullerenes, such as a C₆₀, which in their most preferred form are coated to avoid clustering. The plastic itself, i.e. the work piece to be coated, and the coating material preferably contain the same nanofiller material. This allows advantageously covalent bonds to be created between the piece and the coating during the process. In an application according to the method, nanofillers are added into the plastic, the varnish contains nanofillers, and the coating prepared thereof has a thickness of over 5 μm, most preferably over 10 μm, and a thickness tolerance of less than ±5%, most preferably less than ±1%, and the varnish or the sot-gel coating is spread using the microjet method.

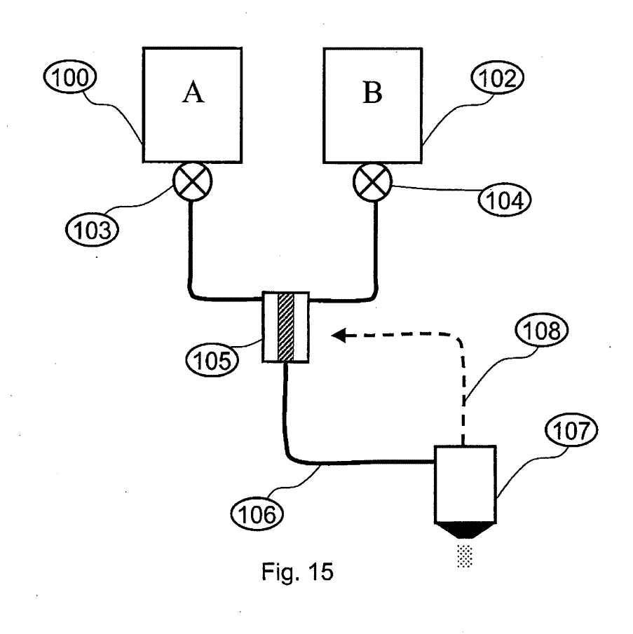

FIG. 15 is a schematic view of a method of the invention and equipment used in the method. The coating material is made of two components A and B. The coating material may be varnish or sol-gel material, for example. In this case the different components of the coating material are kept separate from one another for as long as possible before the coating. The coating material may be a two-component urethane- or epoxy-based varnish, for example. Nanoparticles may be added into the coating material, either to component A or B or to both of them. Components A and B are in their separate containers 100 and 102, and they are not mixed until in a mixing space 105. From the mixing space 105 the coating material is delivered on a common channel 106 to the jetting end 107 of the microjet apparatus. Since the processing time of some coating materials is very short, for example only some minutes, it is advantageous if the distance from the mixing space 105 to the jetting end 107 is as short as possible.

The mixing ratio of the coating material components A and B can be regulated by programming and changed, for example, even in the middle of the run by adjusting the pumping rates of the pumps 103 and 104.

Thin sol-gel surfaces in particular, i.e. typically those having a thickness of 100 to 300 nm, require that the nanoparticles become appropriately mixed with the matrix. Nanoparticles are therefore typically processed so as to minimize their clustering, or even totally prevent it. The nanoparticles, and also materials preventing their clustering, can be first mixed with a diluent, for example.

The containers 100 and 102 of the different components A and B may be provided with heat regulating means and both of them may be adjusted to an optimum temperature of its own. The containers 100 and 102 may be cooled. The components may be kept cold at a temperature of −25° C., for example, all the way to the jetting end 107, which in turn may be heated.

In some cases the characteristics disclosed in this application may be applied as such, irrespective of the other characteristics. On the other hand, the characteristics disclosed herein may be combined, when necessary, to produce different combinations.

The drawings and the related specification are only intended to illustrate the inventive idea. The details of the invention may vary within the scope of the claims.

1.-17. (canceled)

18. A method for producing an optical piece, the method comprising coating an optical work piece with at least one functional coating, producing the optical work piece by extrusion, dispensing a coating material onto the optical work piece by a microjet printer, a plural number of optical pieces being detachable from the coated work piece.

19. A method according to claim 18, wherein the functional coating is a hard coating, an anti-reflection coating and/or an anti-fog coating.

20. A method according to claim 18, wherein the coating comprises an organic varnish, such as siloxane, acrylate and/or polyurethane.

21. A method according to claim 20, wherein the varnish is filled with nanoparticles having a size of 5 to 200 nm.

22. A method according to claim 18, wherein the optical work piece contains nanoparticles deposited therein.

23. A method according to claim 18, comprising coating the anti-reflection surface by a sol-gel method.

24. A method according to claim 18, comprising depositing a first coating onto the surface of the work piece and by depositing a second coating onto the first coating before the first coating is hardened.

25. A method according to claim 18, comprising spreading the material that forms the coating by means of a microjet printer.

26. A method according to claim 25, wherein the microjet printer is an oscillating microjet printer.

27. A method according to claim 25, comprising warming the printer head of the jet printer.

28. A method according to claim 18, comprising coating only one side of the work piece.

29. A method according to claim 28, comprising providing a first side of the work piece with an AR-function film.

30. A method according to claim 28, comprising forming the work piece by extrusion, depositing an AR-function film onto the first side of the still soft work piece and coating the second side of the work piece.

31. A method according to claim 30, wherein the AR-function pattern is on a film that is attached to the first side of the still soft work piece.

32. A method according to claim 18, comprising performing the coating processes in a production system in which the processes are integrated with each other.

33. A method according to claim 18, wherein the coating processes are carried out in an inert gas atmosphere.

34. Equipment for producing an optical piece, the equipment comprising means for coating the optical work piece with at least one functional coating, wherein the equipment comprises a microjet printer configured to dispense coating material onto the optical work piece and means for detaching a plural number of optical pieces from the coated work piece.
